(19) United States
(12) Patent Application Publication
(10) Pub. No.: US 2022/0111276 A1
(43) Pub. Date: Apr. 14, 2022

(54) SPORTS EQUIPMENT WITH CUT OUTS FORMED IN OUTER LAYER OF COMPOSITE MATERIAL

(71) Applicant: TRUE TEMPER SPORTS, INC., Memphis, TN (US)

(72) Inventors: Donald Collins BROWN, Jr., San Diego, CA (US); Brian Christopher MOLLNER, San Diego, CA (US)

(73) Assignee: TRUE TEMPER SPORTS, INC., Memphis, TN (US)

(21) Appl. No.: 17/426,853

(22) PCT Filed: Jan. 29, 2020
(86) PCT No.: PCT/US2020/015636

§ 371 Date: Jul. 29, 2021

Related U.S. Application Data
(60) Provisional application No. 62/802,313, filed on Feb. 7, 2019.

(51) Int. Cl. A63B 60/52; B32B 1/08; B32B 5/12; B32B 37/24; B32B 5/26; B32B 38/00

(52) U.S. Cl. CPC A63B 60/52; B32B 1/08; B32B 5/12; A63B 53/10; B32B 5/26; B32B 38/0004; B32B 37/24

(57) ABSTRACT

A piece of tubular sports equipment includes: a first layer of composite material including fibers oriented in a first direction; a second layer of composite material that directly contacts the first layer of composite material, that is arranged radially outwardly of the first layer of composite material, and that includes fibers oriented in a second direction that is different than the first direction; and a third layer of composite material that directly contacts the second layer of composite material, that is arranged radially outwardly of the second layer of composite material, that includes fibers oriented in a third direction that is different than the second direction, and that includes an aperture formed through the third layer such that a portion of the second layer is visible through the aperture.

### CROSS-REFERENCE TO RELATED APPLICATIONS

The present disclosure is a PCT International Application, which claims the benefit of U.S. Provisional Application No. 62/802,313, filed on Feb. 7, 2019. The entire disclosure of the application referenced above is incorporated herein by reference.

### FIELD

The present disclosure relates to sports equipment and more particularly to composite golf club shafts, hockey stick shafts, hockey stick blades, lacrosse sticks, baseball bats, and other tubular composite sports equipment.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Different sports use different types of equipment. For example, golf clubs and balls are used in the sport of golf, lacrosse sticks and balls are used in the sport of lacrosse, hockey sticks and pucks are used in the sport of hockey, baseball bats and balls are used in the sport of baseball, etc. In golf, golf clubs are used to strike golf balls. In lacrosse, lacrosse sticks are used to pass, shoot, and carry lacrosse balls. In baseball, baseball bats are used to contact baseballs. In hockey, hockey sticks are used to pass, deflect, and shoot hockey pucks.

### SUMMARY

In a feature, a piece of tubular sports equipment includes: a first layer of composite material including fibers oriented in a first direction; a second layer of composite material that directly contacts the first layer of composite material, that is arranged radially outwardly of the first layer of composite material, and that includes fibers oriented in a second direction that is different than the first direction; and a third layer of composite material that directly contacts the second layer of composite material, that is arranged radially outwardly of the second layer of composite material, that includes fibers oriented in a third direction that is different than the second direction, and that includes an aperture formed through the third layer such that a portion of the second layer is visible through the aperture.

In further features, the piece of tubular sports equipment is a golf club shaft.

In further features, the piece of tubular sports equipment is a shaft of a hockey stick.

In further features, the piece of tubular sports equipment is a blade of a hockey stick.

In further features, the piece of tubular sports equipment is a stick of a lacrosse stick.

In further features, the piece of tubular sports equipment is a baseball bat.

In further features, the third direction is different than the first direction.

In further features, the aperture is located between distal ends of the piece of tubular sports equipment.

In further features, the second layer of composite material does not include any apertures through the second layer of composite material.

In further features, a fourth layer of composite material directly contacts the first layer of composite material, is arranged radially inward of the first layer of composite material, and includes fibers oriented in a fourth direction that is different than the first direction.

In further features, a fifth layer of composite material directly contacts the fourth layer of composite material, is arranged radially inward of the fourth layer of composite material, and includes fibers oriented in a fifth direction that is different than the fourth direction.

In further features, each of the first, second, and third layers of composite material includes: fibers; a resin; and an epoxy that chemically reacts with the resin.

In further features, the fibers include graphite fibers.

In further features, the fibers include carbon fibers.

In further features, the fibers include aramid fibers.

In a feature, a method of manufacturing a piece of tubular sports equipment includes: wrapping first, second, and third layers of composite material around a tubular core member such that the first layer is arranged radially inwardly of the second layer and the second layer is arranged radially inwardly of the third layer, where the first layer of composite material includes fibers oriented in a first direction, where the second layer of composite material directly contacts the first layer of composite material and includes fibers oriented in a second direction that is different than the first direction, and where the third layer of composite material directly contacts the second layer of composite material, includes fibers oriented in a third direction that is different than the second direction, and includes an aperture formed through the third layer such that the second layer is visible through the aperture; and curing the first, second, and third layers of composite material to form the piece of tubular sports equipment.

In further features, the method further includes applying paint over the third layer of composite material.

In further features, the method further includes removing the tubular core member from the piece of tubular sports equipment.

In further features, the method further includes, after the curing, trimming the first, second, and third layers of composite material to a target length.

In a feature, a piece of tubular sports equipment includes: a first layer of composite material; a second layer of a metal that directly contacts the first layer of composite material, that is arranged radially outwardly of the first layer of composite material; and a third layer of composite material that directly contacts the second layer, that is arranged radially outwardly of the second layer, and that includes an aperture formed through the third layer such that a portion of the second layer is visible through the aperture.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 includes an example view including (uncured) composite material and a tube used to manufacture a piece of tubular sports equipment, such as a golf club shaft;

FIG. 2 includes a cross-sectional view of the composite material;

FIG. 3 includes a plan view of a tube placed on top of composite material;

FIG. 4 includes a cross-sectional view illustrative of composite material wrapped around the tube;

FIG. 5 includes a plan view of an example outer layer of composite material;

FIG. 6 includes plan view of a tube placed on top of an outer layer of composite material including at least one aperture formed through the outer layer;

FIG. 7 includes a cross-sectional view illustrative of the outer layer wrapped around the tube;

FIG. 8 includes an example illustration of a golf shaft before curing and painting with letters cut out of its outer layer;

FIG. 9A includes an example illustration of the golf shaft of FIG. 8 after curing and painting with a clear paint;

FIG. 9B includes an example illustration of a golf shaft with a pattern cut out of its outer layer after curing and painting with a clear paint;

FIG. 10 includes an example illustration including a hockey stick;

FIGS. 11 and 12 include example illustrations of the outer layer of composite material of the blade portion of a hockey stick including one or more apertures;

FIGS. 13A and 13B include example illustrations of the outer layer of composite material of the handle portion of a hockey stick including one or more apertures;

FIG. 14 includes an example illustration of the outer layer of composite material of the handle portion of a lacrosse stick including one or more apertures;

FIG. 15 includes an example method of manufacturing a piece of sports equipment including at least one aperture formed through an outer layer of composite material; and

FIG. 16 includes an example illustration of the outer layer of composite material of the barrel portion of a baseball bat including one or more apertures.

In the drawings, reference numbers may be reused to identify similar and/or identical elements.

### DETAILED DESCRIPTION

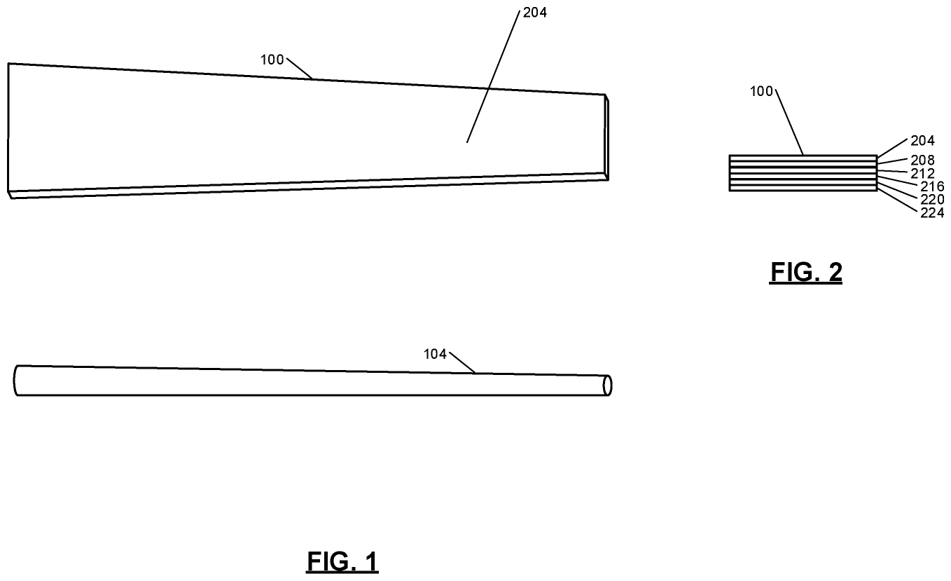

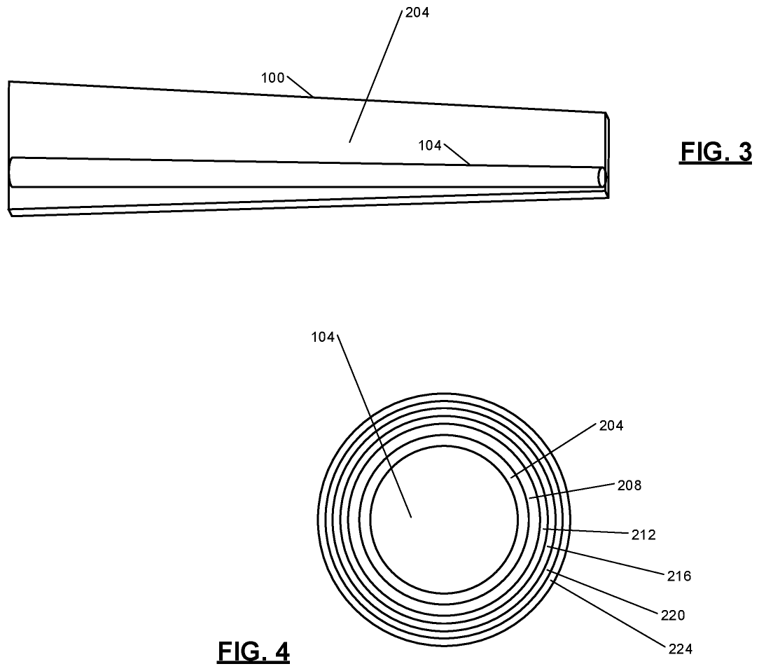

FIG. 1 includes an example view including (uncured) composite material 100 and a tube 104 used to manufacture a golf club shaft. The tube 104 may be referred to as a mandrel. The composite material 100 includes a plurality of different layers. FIG. 2 includes a cross-sectional view of the composite material 100. While the example of the composite material including six layers 204, 208, 212, 216, 220, and 224 is provided, a greater or lesser number of layers may be used.

Each of the layers may include fibers of the composite material, an epoxy, and a resin. For example, each of the layers may include graphite fibers, an epoxy, and a resin. The epoxy chemically reacts with the resin. Directions of the fibers of the composite material of one layer may be different than the directions of the fibers of the composite material of adjacent layers. For example, the fibers of the composite material of the layer 208 may be arranged in a first direction, the fibers of the composite material of the layer 204 may be arranged in a second direction that is different than the first direction, and the fibers of the composite material of the layer 212 may be arranged in a third direction that is different than the third direction. The directions of the fibers may be selected, for example, such that the golf club shaft has target structural (e.g., torsional, bending, etc.) characteristics. For example, the first direction may be parallel to the tube 104 (e.g., 0 degrees relative to the longitudinal axis of the tube 104). The second direction may be, for example, perpendicular to the first direction (e.g., 90 degrees from the first direction). The third direction may be 30 or 45 degrees one of left and right of the first direction. The fourth direction may be 30 or 45 degrees the other one of left and right of the first direction. While examples of directions are provided, other suitable directions may be used. In various implementations, one or more layers may have woven (non-directional) fibers. The fibers may be, for example, graphite, carbon, aramid, glass, or another suitable type of fiber.

In various implementations, the layer 224 may be made of a material that is different than the composite material. For example, the layer 224 may include a metal foil, such as aluminum foil, copper foil, steel foil, or stainless steel foil. While the examples of aluminum, copper, steel, and stainless steel are provided, another suitable material may be used. The layer 224 being made of a metal foil may help achieve one or more structural characteristics, such as bending characteristics, torsional characteristics, etc. In the example of the layer 224 being made of a non-fibrous material (e.g., metal), a resin material may be applied on both surfaces of the layer 224.

The tube 104 may be solid (e.g., metal) or hollow. The tube 104 may be, for example, frustoconical or conical. In various implementations, the composite material 100 may extend past ends of the tube 104. The tube 104 may have different shapes for different types of sports equipment.

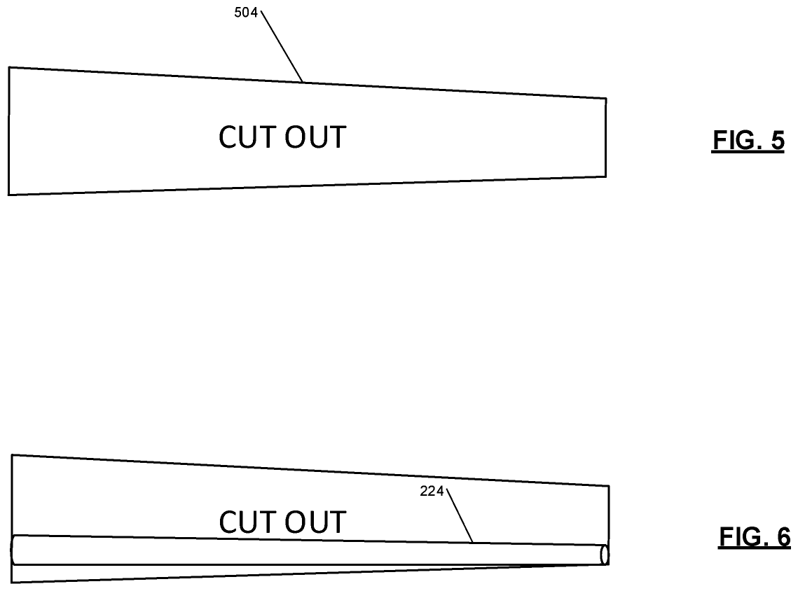

As shown in FIG. 3, the tube 104 is placed on top of the composite material 100. The composite material 100 is wrapped around the tube 104. FIG. 4 illustrates the composite material 100 wrapped around the tube 104. Once the composite material 100 is wrapped around the tube 104, the composite material 100 and the tube 104 may be pressed and rolled, for example, using a platen press.

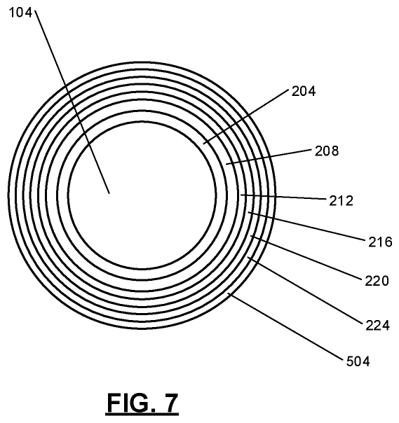

FIG. 5 includes a plan view of an example (uncured) outer layer 504 of composite material. The outer layer 504 also includes fibers of the composite material, an epoxy, and a resin. A portion of (e.g., an interior of) the outer layer 504, however, is cut away. In other words, one or more holes (apertures) are formed through the outer layer 504. For example, the example of FIG. 5 illustrates the words “cut out” being cut out of the outer layer 504. Other things can be cut out of the outer layer 504, such as other words, letters, logos (trademarked or non-trademarked), images, patterns, etc. In various implementations, a cutting device (e.g., a computer numerical control (CNC) cutting machine, such as a CNC router) may cut out the outer layer 504 in response to user input indicative of one or more items to cut out of the outer layer 504.

A direction of the fibers of the outer layer 504 may be the same as or different than a direction of the fibers of the layer 224 (in the example of the layer 224 including fibers) over which the outer layer 504 is applied. The direction of the fibers of the outer layer 504 being different than the direction of the fibers of the layer 224 may make the items cut out of the outer layer 504 more visible and more dramatic. For example only, the direction of the fibers of the outer layer 504 and the direction of the fibers of the layer 224 may be 90 degrees apart. In the example of the layer 224 including a metal foil, the metal foil is visible through the items cut out of the outer layer 504.

The outer layer 504 and the items cut out may improve one or more structural (e.g., torsional, bending, etc.) characteristics of the sports equipment, such as the golf club shaft. The outer layer 504 and the items cut out may additionally or alternatively improve one or more aesthetic characteristics of the sports equipment, such as the golf club shaft.

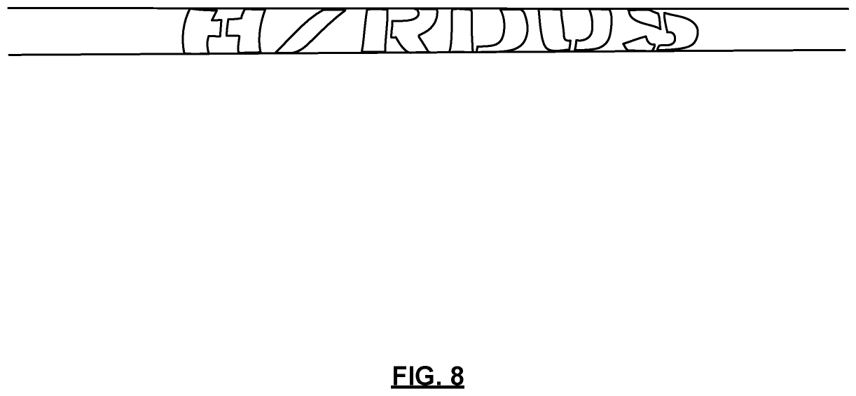

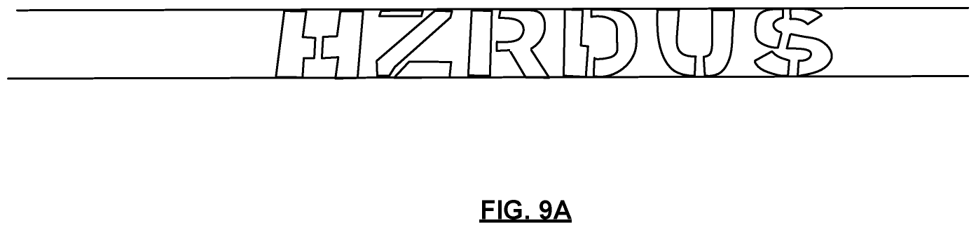

As shown in FIG. 6, the tube 104 is placed on top of the outer layer 504. The outer layer is wrapped around the tube 104. FIG. 7 illustrates the outer layer 504 wrapped around the tube 104. Once the outer layer 504 is wrapped around the tube 104, the outer layer 504 and the tube 104 may again be pressed and rolled, for example, using the platen press. In various implementations, the outer layer 504 may be layed on the composite material 100 (e.g., vertically under 224), and the outer layer 504 and the composite material 100 may be wrapped around the tube 104 concurrently. In this example, one roll pressing may be performed. The thickness of the layers and the outer layer 504 may be equal, or one or more layers may have a different thickness than one or more other layers.

The composite material 100 and the outer layer 504 may be cured (e.g., via heat and/or pressure) to bond the layers of the composite material 100 and the outer layer 504 to create the sports equipment, such as the golf club shaft. The tube 104 can be removed before or after curing. The golf shaft may be trimmed to a target length after the curing. One or more layers of paint may be applied over the outer layer 504 after curing. The paint may be a clear paint or a translucent paint to maintain the visibility of the items cut out of the outer layer 504.

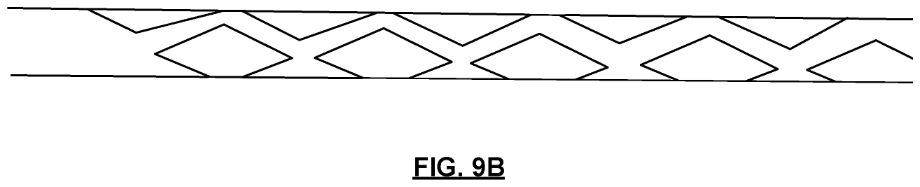

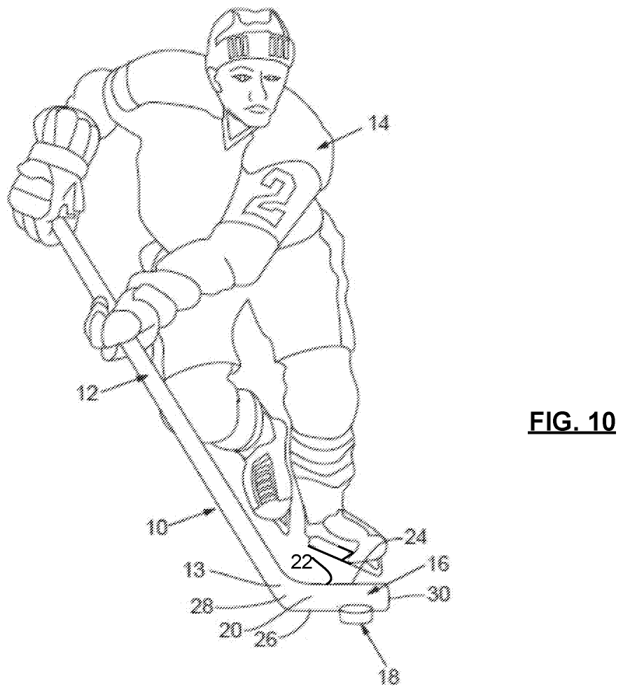

FIG. 8 includes an example illustration of a golf shaft before curing and painting with “HZRDUS” being cut out of its outer layer. FIG. 9A includes an example illustration of the golf shaft of FIG. 8 after curing and painting with a clear paint. FIG. 9B includes an example illustration of a golf shaft with a pattern cut out of its outer layer after curing and painting with a clear paint.

FIG. 10 includes an example illustration including a hockey stick 10. The hockey stick 10 includes a handle portion 12 (i.e., shaft), which a player 14 holds, and a blade portion 16 (i.e., blade), which is used for controlling a hockey puck 18 or a ball. The hockey stick 10 can be adapted for any position on a hockey team, including that of a goalie. In other words, the hockey stick 10 may be a goalkeeper hockey stick or a hockey stick configured to be used by other positions. While the example of an ice hockey stick will be provided, the present application is also applicable field hockey sticks, roller hockey sticks, and other types of sports equipment.

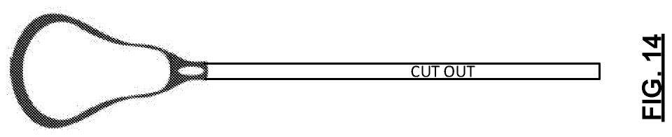

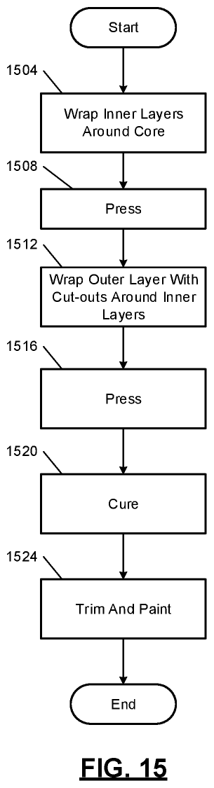

The handle portion 12 can be elongated and longitudinally straight. In some embodiments, the handle portion 12 can include a hollow core that is embedded and wrapped within a covering (e.g., composite material with carbon fibers). The outer layer 504 (with one or more items cut out of the outer layer) can be the outer layer of the handle portion 12. FIGS. 13A and 13B include example illustrations of the outer layer 504 with “cut out” being formed on the handle portion 12. FIG. 14 includes an example illustration of the outer layer 504 with “cut out” being formed on the handle portion of a lacrosse stick. One or more items cut out of the outer layer can be positioned on any one or more sides of the handle portion of a hockey stick or a lacrosse stick.

The handle portion 12 includes a blade connecting end 13. The blade portion 16 is fixed to the blade connecting end 13 of the handle portion 12. The blade portion 16 can be fixed to the blade connecting end 13 in any suitable manner. The handle portion 12 and the blade portion 16 can be manufactured separately and subsequently attached together. Alternatively, the handle portion 12 and the blade portion 16 may be manufactured together.

The blade portion 16 generally includes a front face 20, which can be used for receiving and moving the hockey puck 18 (e.g., passing, shooting, etc.), and a rear face 22, which can also be used for receiving and moving the hockey puck 18. The blade portion 16 also includes a first end 28 that is connected to the blade connecting end 13 of the handle portion 12. The blade portion 16 also includes a second end 30 that is opposite to the first end 28.

The blade portion 16 also includes an upper edge 24 and a lower edge 26 that is opposite the upper edge 24. The upper edge 24 is typically spaced away from a playing surface (e.g., ice). The lower edge 26 may contact the playing surface.

Both the upper and lower edges 24 and 26 extend between the first and second ends 28 and 30 of the blade portion 16. The upper and lower edges 24 and 26 and the front and rear faces 20 and 22 can have a curvature between the first and second ends 28 and 30 such that the front face 20 is concave while the rear face 22 is convex.

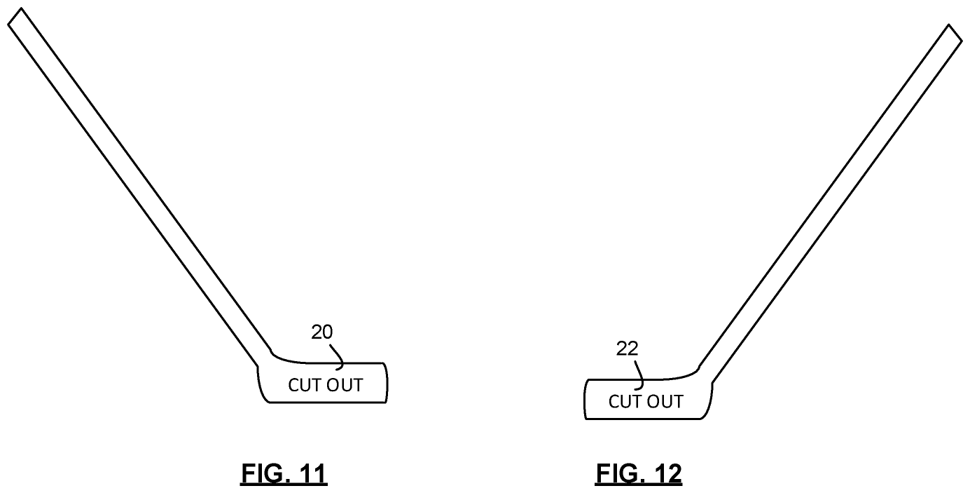

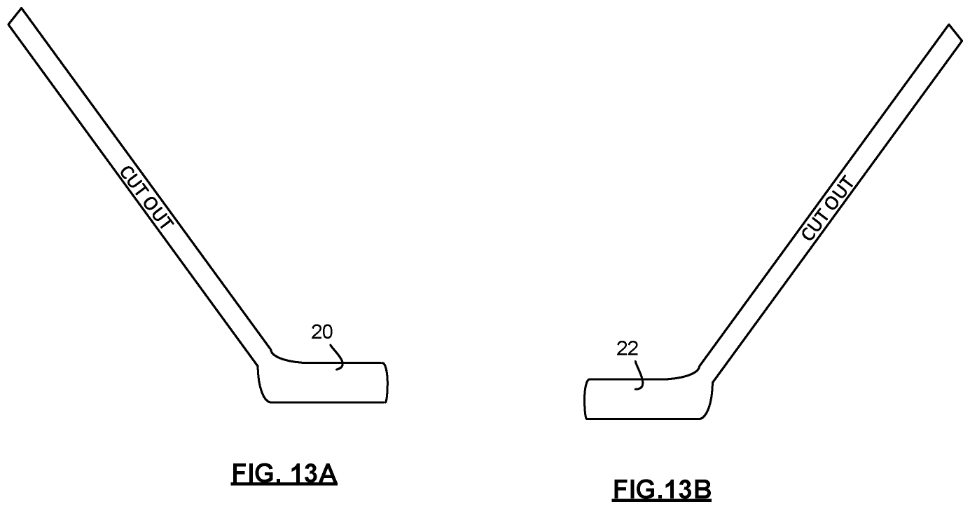

The blade portion 16 includes a covering that is wrapped around one or more core members. The covering includes one or more layers of composite material, similar to the golf club shaft described above. The outer layer 504 (with one or more items cut out of the outer layer) can be the outer layer of the blade portion 16. The one or more items that are cut out of the outer layer 504 can be located on the front face 20, the rear face 22, or both of the front and rear faces 20 and 22. FIGS. 11 and 12 include example illustrations of the outer layer 504 with “cut out” being formed on the blade portion 16.

FIG. 16 includes an example illustration including a baseball bat 1604 including the outer layer 504 having one or more apertures. The baseball bat 1604 includes a handle portion 1608, which a player holds, and a head or barrel portion 1612, which is used to bat/contact a ball. The handle portion 1608 and the barrel portion 1612 may be separate pieces that are integrated together or may be a single monolithic piece. While the example of apertures formed in the outer layer 504 of the barrel portion 1612 is shown in FIG. 16, additionally or alternatively one or more apertures may be formed in the outer layer 504 of the handle portion 1608.

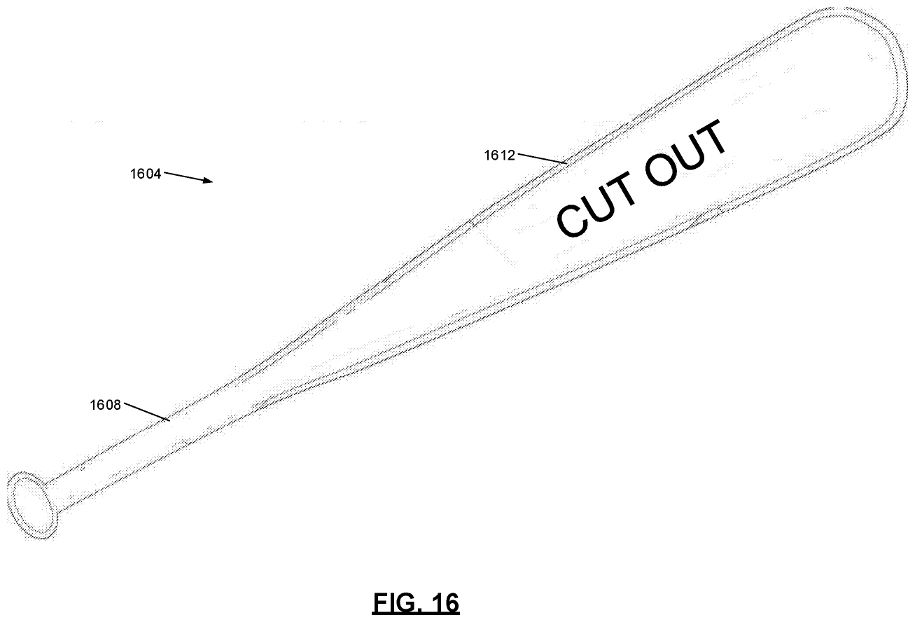

FIG. 15 includes an example method of manufacturing a piece of sporting equipment, such as a golf club shaft, a hockey stick shaft, a hockey stick blade, a lacrosse stick, or a baseball bat. The method begins with 1504 where one or more inner layers of composite material (e.g., 100) are wrapped around one or more core members (e.g., the tube 104, the core(s) used to form a hockey stick shaft or blade, or another suitable type of tubular core member). At 1508, the one or more inner layers may be pressed toward the core member(s), for example, using a platen press. Heat may also be applied.

At 1512, the outer layer 504 with one or more items cut out of the outer layer 504 (i.e., one or more apertures formed through the outer layer 504) are wrapped around the inner layer(s) and the core member(s). At 1516, the outer layer may be pressed toward the core member(s), for example, using a platen press. Heat may also be applied.

At 1520, the outer layer and the inner layer(s) are cured. The outer layer and the inner layers may be cured, for example, by heating at at least a predetermined temperature for at least a predetermined period. Optionally (e.g., in the example of the golf club shaft), trimming and paint is applied over the outer layer at 1524.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A piece of tubular sports equipment comprising:
a first layer of composite material including fibers oriented in a first direction;
a second layer of composite material that directly contacts the first layer of composite material, that is arranged radially outwardly of the first layer of composite material, and that includes fibers oriented in a second direction that is different than the first direction; and
a third layer of composite material that directly contacts the second layer of composite material, that is arranged radially outwardly of the second layer of composite material, that includes fibers oriented in a third direction that is different than the second direction, and that includes an aperture formed through the third layer such that a portion of the second layer is visible through the aperture.

2. The piece of tubular sports equipment of claim 1 wherein the piece of tubular sports equipment is a golf club shaft.

3. The piece of tubular sports equipment of claim 1 wherein the piece of tubular sports equipment is a shaft of a hockey stick.

4. The piece of tubular sports equipment of claim 1 wherein the piece of tubular sports equipment is a blade of a hockey stick.

5. The piece of tubular sports equipment of claim 1 wherein the piece of tubular sports equipment is a stick of a lacrosse stick.

6. The piece of tubular sports equipment of claim 1 wherein the piece of tubular sports equipment is a baseball bat.

7. The piece of tubular sports equipment of claim 1 wherein the third direction is different than the first direction.

8. The piece of tubular sports equipment of claim 1 wherein the aperture is located between distal ends of the piece of tubular sports equipment.

9. The piece of tubular sports equipment of claim 1 wherein the second layer of composite material does not include any apertures through the second layer of composite material.

10. The piece of tubular sports equipment of claim 1 further comprising a fourth layer of composite material that directly contacts the first layer of composite material, that is arranged radially inward of the first layer of composite material, and that includes fibers oriented in a fourth direction that is different than the first direction.

11. The piece of tubular sports equipment of claim 10 further comprising a fifth layer of composite material that directly contacts the fourth layer of composite material, that is arranged radially inward of the fourth layer of composite material, and that includes fibers oriented in a fifth direction that is different than the fourth direction.

12. The piece of tubular sports equipment of claim 1 wherein each of the first, second, and third layers of composite material includes:
fibers;
a resin; and
an epoxy that chemically reacts with the resin.

13. The piece of tubular sports equipment of claim 1 wherein the fibers include graphite fibers.

14. The pieces of tubular sports equipment of claim 1 wherein the fibers include carbon fibers.

15. The pieces of tubular sports equipment of claim 1 wherein the fibers include aramid fibers.

16. A method of manufacturing a piece of tubular sports equipment, comprising:
wrapping first, second, and third layers of composite material around a tubular core member such that the first layer is arranged radially inwardly of the second layer and the second layer is arranged radially inwardly of the third layer,
wherein the first layer of composite material includes fibers oriented in a first direction,
wherein the second layer of composite material directly contacts the first layer of composite material and includes fibers oriented in a second direction that is different than the first direction, and
wherein the third layer of composite material directly contacts the second layer of composite material, includes fibers oriented in a third direction that is different than the second direction, and includes an aperture formed through the third layer such that the second layer is visible through the aperture; and
curing the first, second, and third layers of composite material to form the piece of tubular sports equipment.

17. The method of claim 16 further comprising applying paint over the third layer of composite material.

18. The method of claim 16 further comprising removing the tubular core member from the piece of tubular sports equipment.

19. The method of claim 16 further comprising, after the curing, trimming the first, second, and third layers of composite material to a target length.

20. A piece of tubular sports equipment comprising:
a first layer of composite material;
a second layer of a metal that directly contacts the first layer of composite material, that is arranged radially outwardly of the first layer of composite material; and
a third layer of composite material that directly contacts the second layer, that is arranged radially outwardly of the second layer, and that includes an aperture formed through the third layer such that a portion of the second layer is visible through the aperture.
